(19) United States
(12) Patent Application Publication
(10) Pub. No.: US 2003/0048184 A1
(43) Pub. Date: Mar. 13, 2003

(54) Communication independent identification unit

(76) Inventor: Bjorn de Bonnenfant, Stockholm (SE)

Correspondence Address: HARNESS, DICKEY & PIERCE, P.L.C., P.O. BOX 8910, RESTON, VA, 20195, US

(21) Appl. No.: 10/168,979

(22) PCT Filed: Dec. 29, 2000
(86) PCT No.: PCT/SE00/02694

(30) Foreign Application Priority Data
Dec. 30, 1999 (SE) 9904865-4

(51) Int. Cl. G08B 1/00

(52) U.S. Cl. 340/531; 340/539; 340/993; 340/426; 340/825.72

(57) ABSTRACT

A communication independent identification unit (2), provided with a unique identity code (7) and including an activation device (4) and a transmitter (3) arranged to transmit information when the activation device (4) is activated, the information include at least the identity code (7) of the unit (2), the activation type and the final destination of the information. The transmitter (3) is capable of transmitting information over short distances to a long distance communication link (5), and is arranged to control the long distance communication link (5) to forward the information to its final destination. The unit (2) may further include a GPS receiver.

### TECHNICAL FIELD

The present invention relates to a communication independent identification unit according to the preamble of claim 1, a system including a such unit and a method for using a such unit.

### BACKGROUND OF THE INVENTION

Units that may send alarms or other information regarding the position or need of the units bearer to a central unit via some communication link, when the bearer manually activates an alarm button, or when a detector automatically trigs an alarm dependent on the condition of the bearer are commercially available. The alarm function may, as an example, comprise of an actual alarm that activates manually of the bearer or of some type of detecting system that monitors the physical condition of the bearer, for instance the pulse of a bearer with a heart condition may be monitored and an alarm is trigged when the bearer shows symptom of an emergency state of illness. The alarm function may also be used for other purposes than to indicate an alarm for assault, attempted robbery or emergency illness, e.g. such as to indicate the identity of the bearer via the unit to, in this way, activate opening of doors, locking or unlocking of doors or the like.

The characterising feature of all these devices is that the alarm function is transmitted from the unit via a long distance communication unit included in the device or connected to the device. The information will not reach the destination if the communication unit is out of order when the alarm is activated. Long distance communication units, e.g. GSM telephones tends to consume more effect than simpler units for communication over short ranges, e.g. such as Blue Tooth transmitters or transmitters using WAP. Further, they are heavier, larger and more expensive. A method for reducing the risk that the alarm does not reach the destination is to connect several long distance communication links to secure that at least one operates at each alarm occasion, further resulting in increased total power consumption, weight and volume.

### SUMMARY OF THE INVENTION

It is an object with the present invention to provide a system, a unit and a method, in which the disadvantage that the unit has to carry a comparatively heavy, expensive and power consuming long distance communication unit is avoided. It is furthermore an object of the invention to provide a system, a unit and a method, in which the alarm may reach a central unit via one out of several long distance units being within range of a short distance communication unit, resulting in an increased security. This and other objects are achieved by a system, a unit and a method according to the characterising portions of the independent claims. In this one or several of the below mentioned advantageous properties or functions are achieved.

According to the invention an unit is provided that manually or automatically may be activated to send an alarm to a central unit via a long distance communication unit within the range of a short distance communication unit included in the unit.

According to another aspect of the invention an unit is provided including a device that may state the location of the unit and pass on this information to a central unit to give the receiver of the a arm further information regarding the position of the bearer.

According to the invention a system is further provided that helms the bearer of a unit to identify him self electronically to in that way activate door opening, locking/unlocking or doors or the like.

### BRIEF DESCRIPTION OF DRAWINGS

FIG. 1 shows a schematic picture over the total system

### DESCRIPTION OF PREFERRED EMBODIMENTS

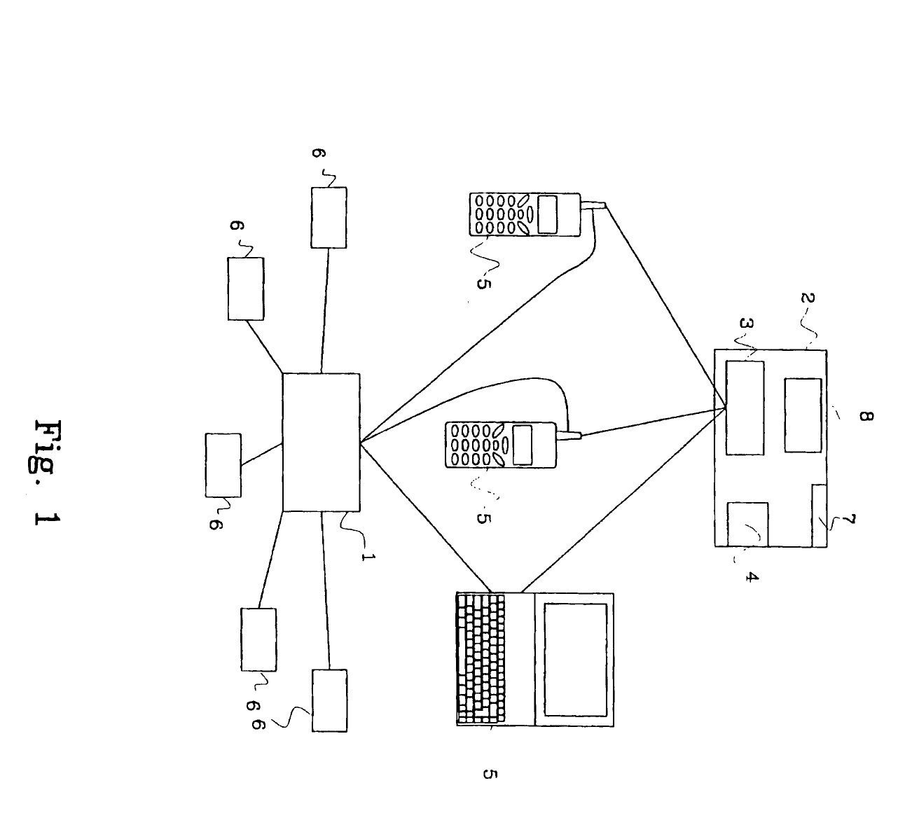

FIG. 1 schematically shows the whole system comprises at least one mobile unit 2, the central unit 1 and customer units 6. Further it is shown how the mobile unit 2 comprises a transmitter 3 and an activating unit 4 and how each mobile unit 2 is provided wish an identification number 7.

The information from the transmitter is transferred with some kind of protocol for short distance communication between a pair of transmitter/receiver in a group of several transmitters and receivers, that may communicate with each other. The protocol may for example be Bluetooth, Wireless Application Protocol (WAP) or IRDA. The transmitter will, when activated by an alarm or other request for information transmittal, search for a receiver within range for the transmitter and request that the unit forwards the information to the central unit 1. In the case when it concerns an alarm, such as an assault alarm or an alarm indicating that the bearer has an emergency state of illness, that information sent to the receiving unit include a request of forwarding the information to the central unit. The information may, in the case when the receiver is a GSM telephone, be transmitted via radio communication to a central unit and in the case when the receiver is a computer connected to internet, be transmitted via internet to the central unit. The central unit 1 stores the received information for each object and may forward it to a customer unit 6, or the central unit 6 may be placed at the customer and thus be the only customer unit.

The alarm may be trigged in numerous ways for optimised reliability and security. In the simplest embodiment, the communication unit 2 is provided with a unit for manual initiation of an alarm, e.g. implemented as simple as a switch, or in combination of two switches that have to be activated at the same time to trig an alarm. In a more advanced embodiment, a unit that monitors the bearer and automatically trigs an alarm is present if some measurement parameter goes outside a predetermined interval. Parameters that the unit may monitor is the pulse frequency, blood pressure and sugar content in the blood. The unit may be provided with an annulment button, to prevent erroneously trigged automatic alarms as far as possible, and the alarm is transmitted only if the alarm not has been annulled by the bearer within a certain time.

The communication independent identification unit may furthermore be provided with a device for calculating of the position of the unit, e.g. a GPS receiver. When an alarm is trigged, information regarding the geographical position of the unit is also transmitted to the central unit, that makes it easier for an ambulance or the police to find the bearer of the unit.

The information from the unit may be transmitted by short distance communication to some control device to open a door, without linking the information further to a central unit 1. In the case when the request concerns control of a control device, the receiving unit make sure that the request is performed if the identity of the bearer gives the bearer the right to request, for instance, opening of a door.

Even though the invention has been described in connection to a preferred embodiment it should be understood that several modifications may be performed without departing from the scope of the invention.

1. A communication independent identification unit (2) being provided with a unique identification code (7) and the unit (2) including an activation device (4) and a transmitter (3) arranged to transmit information when the activation device (4) is activated, the information including at least the identity code (7) of the unit (2), type of activation and the final destination of the information, characterised in
that the transmitter (3) is capable of transmitting information over short distances to a long distance communication link (5), and
that the transmitter (3) is arranged to control the long distance communication link (5) to forward the information to the final destination

2. The unit according to claim 1, wherein the transmitter (3) is a Bluetooth transmitter.

3. The unit according to claim 1, wherein the transmitter (3) is a IrDA transmitter.

4. The unit according to any of claims 1-3, wherein the transmitter (3) is a transmitter using Wireless Application Protocol.

5. The unit according to any of claims 1-4, wherein the mobile unit (2) include a receiver (8) of signals from at least three satellites, arranged that from these signals calculate the position of the mobile unit, and the transmitter (3) is arranged to transmit information regarding the position of the unit (2).

6. The unit according to claim 5, wherein said receiver (4) is a GPS receiver.

7. The unit according to any of the preceding claims, wherein the transmitter (3) is capable of transmitting information of the identity code (7) of the unit (2) over short distances to a final destination, for activation of automatic.

8. The unit according to any of the preceding claims, wherein, the activation device (4) include an alarm unit that is automatically activated of a detecting system.

9. The unit according to claim 8, wherein the activation device (4) is activated when the automatic alarm activation is not deactivated manually.

10. The unit according to any of the preceding claims, wherein the activation device (4) include a manually activated alarm unit.

11. A system including the unit (2) according to any of the preceding claims, and at least one central unit (1).

12. A method for transferring information including an identity code (7), activity and final destination for the unit (2) provided with a unique identity code (7) to a final destination, the unit (2) including an activation device (4) and a transmitter (3), said method including the following step:
activation of the activation device (4) characterised in that the method include the further steps:
the transmitter (3) searching for a long distance communication unit (5), that is within the range for the transmitter,
the transmitter transfer information to the long distance communication unit (5) regarding the identity code of the unit and the destination of the information, and
instructing the long distance communication unit (5) to transfer the information to the destination.

13. The method according to claim 12, wherein the alarm function is activated manually.

14. The method according to claim 12, wherein the alarm function is activated when an automatic alarm activation is not deactivated manually.

15. The method according to any of claims 12-14, wherein the transmitter (3) is capable to transmit information regarding the identity code (7) of the unit (2) over short distances to a final destination, for activation of automatic.

16. The method according to any of claims 12-15, wherein the unit (2) further transmits information regarding its position provided from a unit for receiving signals from at least three satellites, from which signals the position of the unit (2) may be calculated.
